(19) United States
(12) Patent Application Publication
(10) Pub. No.: US 2025/0305667 A1
(43) Pub. Date: Oct. 2, 2025

(54) ADJUSTABLE ILLUMINATION RANGE LIGHTING APPARATUS

(71) Applicant: Grit Technology Corporation, New Taipei (TW)

(72) Inventor: Te Sheng Huang, New Taipei (TW)

(21) Appl. No.: 19/240,191

(22) Filed: Jun. 17, 2025

(51) Int. Cl. F21V 23/04; F21V 5/00; F21Y 105/18; F21Y 113/00; F21Y 115/10

(52) U.S. Cl. CPC F21V 23/04; F21V 5/002; F21Y 2105/18; F21Y 2113/00; F21Y 2115/10

(57) ABSTRACT

Most conventional LED lighting devices emit light in a fixed direction and beam angle. When changes in illumination area are needed, users often must move the fixture or install additional lighting units, which leads to inconvenience and reduced efficiency. Traditional devices rely on secondary optics or fixed housing to adjust beam shape, but they lack real-time dynamic control. There is therefore a demand for a lighting structure that can rapidly switch between spotlight and floodlight modes to improve usability and lighting flexibility.

The present invention relates to a lighting apparatus with an adjustable illumination range, and more particularly to a lighting device that enables users to selectively switch between spotlight and floodlight modes in real time via an external control switch, according to their lighting needs.

### BACKGROUND OF THE INVENTION

Light Emitting Diodes (LEDs) are generally applied in two major categories: illumination and display. For example, single-color LEDs have been widely adopted for lighting purposes, while multi-color or full-color LEDs better satisfy visual requirements in display applications.

Due to their high brightness and low power consumption, LEDs have been extensively used in indoor, outdoor, and specialized lighting applications. Conventional LED lighting fixtures primarily emit light perpendicular to the LED package's light-emitting surface, and rely on secondary optical design or fixture structure to achieve specific luminous intensity, beam angles, and light distribution curves to meet various lighting needs.

However, the fixed installation position of conventional LED lighting fixtures restricts the flexibility of the LED light source, thereby imposing usage limitations. As a result, such lighting devices can only provide fixed luminous intensity, beam angle, and distribution curve to illuminate a specific target or fixed area. If it becomes necessary to illuminate another area or to broaden the illumination range, the user must manually reposition the LED lighting device or install an additional fixture in the desired area.

Accordingly, the present invention aims to address this issue by providing a lighting device that allows users to dynamically control spotlighting or floodlighting modes in real time based on their needs.

### SUMMARY OF THE INVENTION

To address the problems and deficiencies of the prior art, the present invention provides a lighting apparatus with an adjustable illumination range. The apparatus comprises an LED panel and a light diffusion plate. A first lighting zone is disposed on one side of the LED panel and includes a plurality of first LEDs. Surrounding the first lighting zone, at least one ring-shaped second lighting zone is provided, which includes a plurality of second LEDs arranged in a surrounding configuration. The LED panel is configured to selectively activate only the plurality of first LEDs in the first lighting zone, or simultaneously activate both the first and second LEDs in the respective zones, or further activate only the plurality of second LEDs in the second lighting zone. The light diffusion plate is disposed over one side of the LED panel and covers both the first and second lighting zones. A plurality of diffusion lenses are formed in the light diffusion plate at positions corresponding to the second lighting zone, with each diffusion lens aligned to one of the second LEDs.

The LED panel is electrically connected to an externally preset control switch, which allows selective activation of only the first LEDs in the first lighting zone, thereby producing a first lighting mode with a spotlight effect. Alternatively, the control switch can simultaneously activate the first and second LEDs. When the second LEDs are illuminated, their emitted light passes through the diffusion lenses of the light diffusion plate, creating a refraction-based diffusion of the light source and resulting in a second lighting mode with a full-area floodlight effect. Furthermore, the control switch may be used to activate only the second LEDs in the second lighting zone, thereby providing a third lighting mode with a peripheral floodlight effect.

The present invention further discloses another embodiment of the adjustable illumination range lighting apparatus, which includes an LED panel. A first lighting zone is disposed on one side of the LED panel and includes a plurality of first LEDs. At least one ring-shaped second lighting zone is provided surrounding the first lighting zone, and includes a plurality of second LEDs. Each second LED is directly coupled with a diffusion lens mounted on its light-emitting surface. The LED panel is capable of selectively activating only the first LEDs, both the first and second LEDs, or only the second LEDs.

The LED panel is electrically connected to a preset external control switch, which allows the lighting apparatus to operate in three distinct lighting modes. When only the first LEDs are activated, the lighting device provides a spotlight effect as the first lighting mode. When both the first and second LEDs are activated, and the second LEDs emit light that passes through the integrated diffusion lenses, a full-area floodlight effect is achieved, representing the second lighting mode. When only the second LEDs are activated, a localized floodlight effect is provided as the third lighting mode.

The technical feature of the present invention lies in the configuration of the LED panel with distinct first and second lighting zones, and the use of a control switch to selectively activate: (1) only the first zone, (2) both zones simultaneously, or (3) only the second zone. When only the first zone is activated, the centrally located first LEDs produce light, resulting in a spotlight effect for the first lighting mode. When both zones are activated, the second LEDs, located along the edges of the panel, emit light that passes through the diffusion lenses of the light diffusion plate or integrated lens elements, enabling wide-angle illumination from the second lighting zone. This results in a full-area floodlight effect for the second lighting mode. When only the second zone is activated, light is emitted solely from the edge-positioned second LEDs, creating a peripheral floodlight effect for the third lighting mode. Thus, the invention allows users to dynamically select between spotlight and floodlight modes based on their lighting requirements.

### BRIEF DESCRIPTION OF THE DRAWINGS

FIG. 1 is an assembled view of the lighting apparatus with adjustable illumination range according to the present invention.

FIG. 2 is an exploded view of a first embodiment of the lighting apparatus with adjustable illumination range according to the present invention.

FIG. 3 is a schematic diagram of the LED panel module in the first embodiment of the lighting apparatus with adjustable illumination range according to the present invention.

FIG. 4 is a schematic diagram of the light diffusion plate of the lighting apparatus with adjustable illumination range according to the present invention.

FIG. 5 is a schematic diagram of a first control embodiment of the lighting apparatus with adjustable illumination range according to the present invention.

FIG. 6 is a schematic diagram of a second control embodiment of the lighting apparatus with adjustable illumination range according to the present invention.

FIG. 7 is an exploded view of a second embodiment of the lighting apparatus with adjustable illumination range according to the present invention.

FIG. 8 is a schematic diagram of the LED panel module in the second embodiment of the lighting apparatus with adjustable illumination range according to the present invention.

FIG. 9 is a schematic diagram of a first application embodiment of the lighting apparatus with adjustable illumination range according to the present invention.

FIG. 10 is a schematic diagram of a second application embodiment of the lighting apparatus with adjustable illumination range according to the present invention.

FIG. 11 is a schematic diagram of a third embodiment of the lighting apparatus with adjustable illumination range according to the present invention.

### DETAILED DESCRIPTION OF THE INVENTION

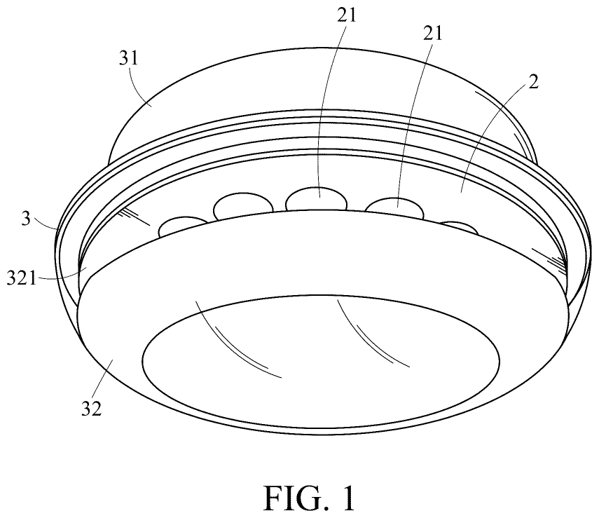

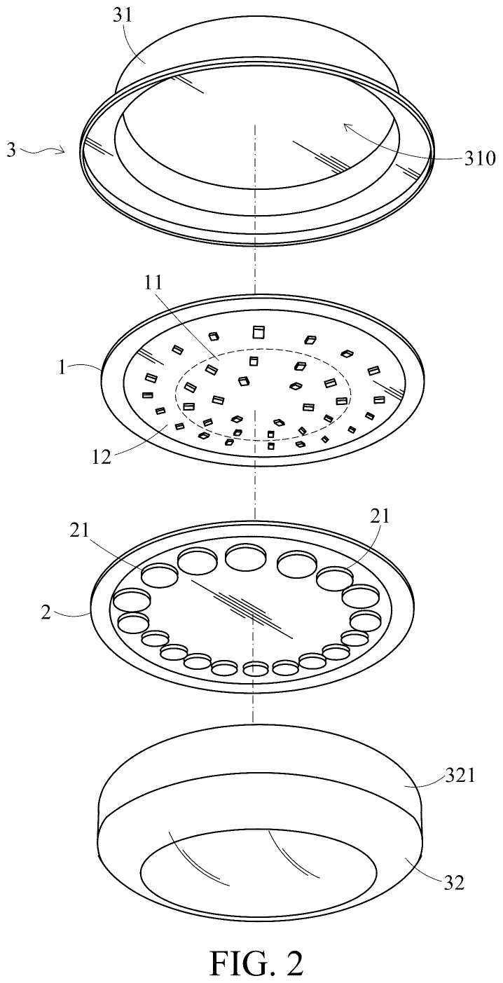

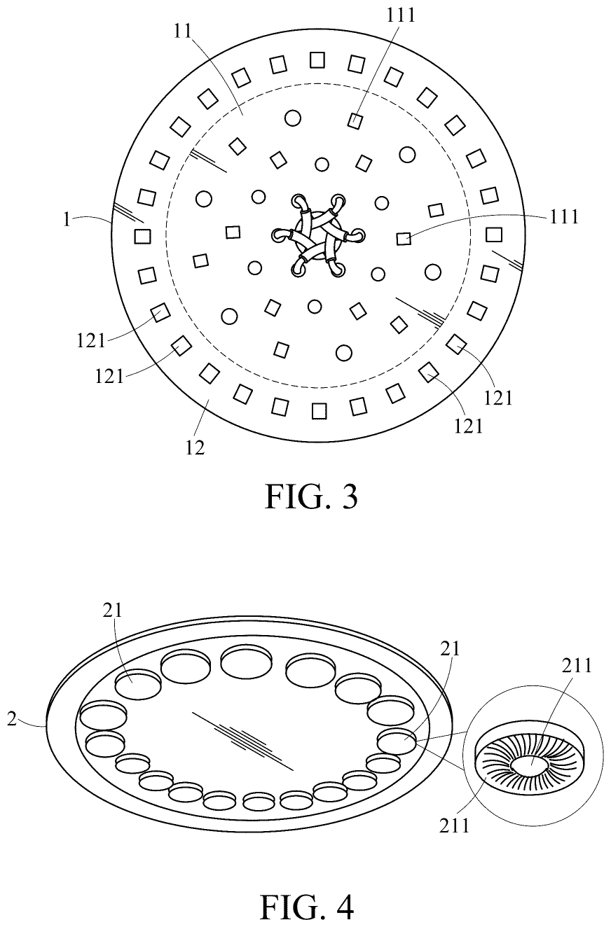

Please refer to FIGS. 1 to 6. The present invention discloses a lighting apparatus with an adjustable illumination range, which may be installed in dry or damp environments. The apparatus comprises an LED panel 1, a light diffusion plate 2, and a lamp housing 3.

The LED panel 1 has a first lighting zone 11 disposed on one side thereof, which may be located at the center of the panel and includes a plurality of first LEDs 111. Surrounding the first lighting zone 11 is at least one ring-shaped second lighting zone 12, which includes a plurality of second LEDs 121 arranged in a surrounding pattern. In some embodiments, the LED panel 1 includes one or more concentric second lighting zones 12 outside the first lighting zone 11. The LED panel 1 is configured to selectively activate only the first LEDs 111 in the first lighting zone 11, or both the first LEDs 111 and second LEDs 121 simultaneously, or only the second LEDs 121 in the second lighting zone 12. The panel operates under a voltage range between 12V and 240V.

The light diffusion plate 2 is a light-transmissive sheet made from plastic, glass, or other transparent materials. It is disposed over one side of the LED panel 1, covering both the first lighting zone 11 and the second lighting zone 12. The area of the diffusion plate 2 covering the first lighting zone 11 may be flat or curved, while the area covering the second lighting zone 12 is provided with a plurality of diffusion lenses 21, each corresponding to a second LED 121. The surfaces of the diffusion lenses 21 may be formed with a plurality of convex elements 211, such as circular or elongated protrusions, to enhance light dispersion.

The lamp housing 3 comprises a lamp base 31 and a lamp cover 32. The lamp base 31 is formed with a receiving chamber 310 in which the LED panel 1 is disposed. The lamp cover 32 is coupled with the lamp base 31 to enclose the receiving chamber 310, LED panel 1, and light diffusion plate 2. The lamp cover 32 includes a circumferential sidewall 321, which may be transparent or semi-transparent (e.g., frosted) to provide light diffusion.

The LED panel 1 is electrically connected to an external control switch 4 (as shown in FIG. 9). The control switch 4 may be a manual push-button switch or a remote control switch. The remote control switch may include a mobile phone application (App) linked to the LED panel 1 via Bluetooth or Wi-Fi, or an infrared (IR) remote control. The switch may also be configured as a voice-activated controller.

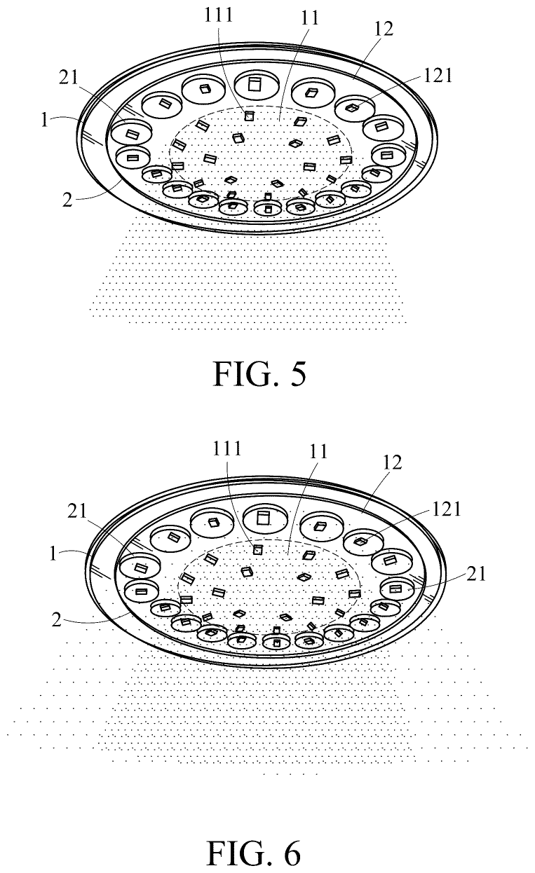

The control switch 4 allows the LED panel 1 to operate in three distinct lighting modes:
(1) Activate only the first LEDs 111 in the first lighting zone 11 for a spotlight lighting mode (FIG. 5), with a beam angle between 100° and 120°.
(2) Activate both the first LEDs 111 and the second LEDs 121 in the second lighting zone 12 for a full-area floodlight mode (FIG. 6). The light from the second LEDs 121 is refracted and diffused through the diffusion lenses 21, achieving a wide illumination angle between 140° and 160°.
(3) Activate only the second LEDs 121 in the second lighting zone 12 to create a peripheral floodlight mode.

When the second LEDs 121 are illuminated, their light passes through the lamp cover 32 and its sidewall 321, providing light diffusion through transparent or semi-transparent materials. The central region of the lamp cover 32 may be frosted to reduce glare.

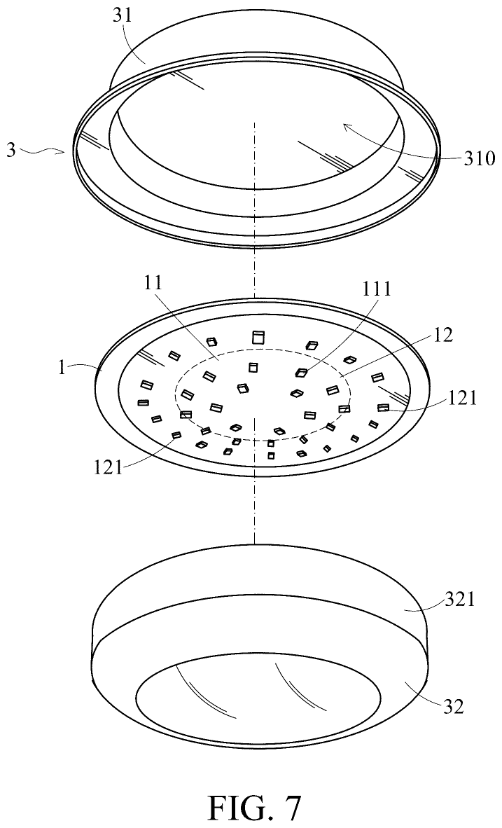

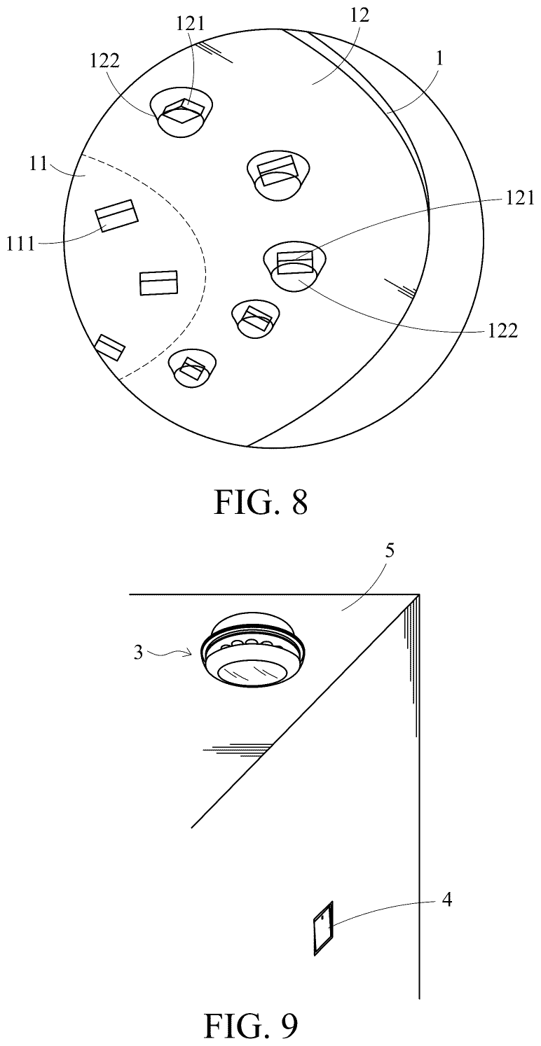

Please also refer to FIGS. 7 and 8. The present invention further discloses another embodiment of the lighting apparatus, which includes an LED panel 1 and a lamp housing 3. The LED panel 1 has the same basic structure as described above, with a central first lighting zone 11 including a plurality of first LEDs 111 and one or more concentric second lighting zones 12 including second LEDs 121. The distinction lies in that each second LED 121 is provided with a diffusion lens 122 directly mounted over its light-emitting surface, thereby eliminating the need for a separate light diffusion plate 2.

The lamp housing 3 is also similar to the previous embodiment, comprising a lamp base 31 with a receiving chamber 310 to hold the LED panel 1, and a lamp cover 32 that encloses the chamber and the panel.

The LED panel 1 is again connected to the external control switch 4, which allows switching between the three lighting modes described previously, including spotlight, full-area floodlight, and peripheral floodlight, depending on which combination of LEDs are activated. In this embodiment, the second LEDs 121 directly emit diffused light through the integrated diffusion lenses 122.

Please refer to FIG. 9. In a first application embodiment, the lamp housing 3 is mounted directly to a ceiling 5, and the control switch 4 is mounted to a wall 6. The user may operate the switch to toggle between spotlight and floodlight modes.

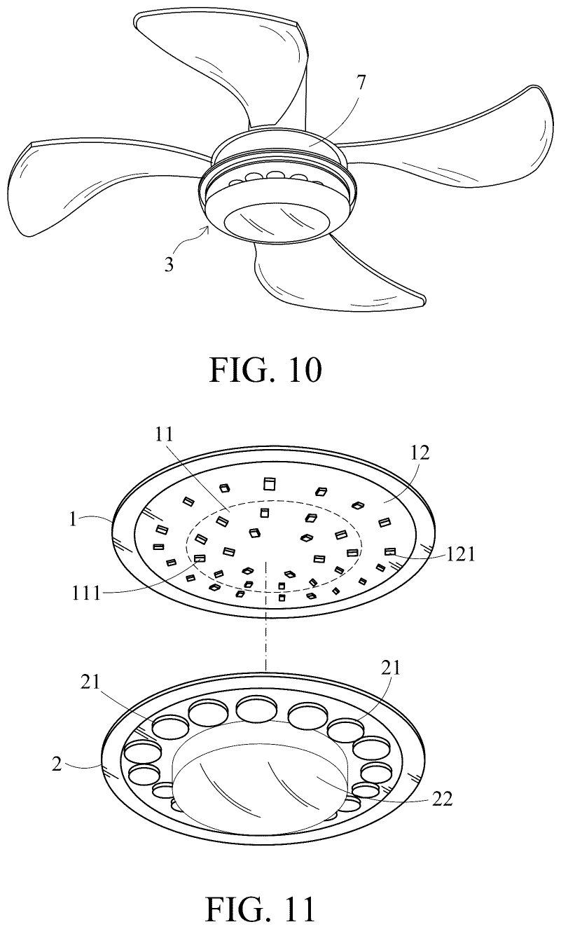

Please refer to FIG. 10. In a second application embodiment, the lamp housing 3 is mounted to a ceiling fan 7. The control switch 4 may be wall-mounted or provided as a remote controller, allowing the user to control the lighting mode conveniently.

Please refer to FIG. 11. In a third embodiment, the light diffusion plate 2 includes a convex lens portion 22 protruding from the region corresponding to the first lighting zone 11. The convex portion 22 may be cylindrical, rectangular, or of another shape. When the first LEDs 111 are activated, the convex portion 22 provides a focused light effect, for example, a beam angle of approximately 100° to 120°.

In summary, the lighting apparatus of the present invention features an LED panel 1 having a first lighting zone 11 and a second lighting zone 12. A control switch 4 allows selective activation of only the first zone, both zones simultaneously, or only the second zone.

When only the first zone is activated, a spotlight effect is achieved.

When both zones are activated, the first and second LEDs cooperate to produce wide-angle illumination through either the diffusion plate 2 or the integrated lens 122, forming a full-area floodlight effect.

When only the second zone is activated, the peripheral second LEDs 121 emit diffused light, producing a third lighting mode with peripheral floodlighting.

This allows the user to dynamically adjust lighting based on actual requirements.

1. A lighting apparatus with an adjustable illumination range, comprising:
An LED panel, having a first lighting zone disposed on one side thereof, the first lighting zone being provided with a plurality of first LEDs, and at least one ring-shaped second lighting zone disposed around the first lighting zone, the second lighting zone being provided with a plurality of second LEDs;
A light diffusion plate, disposed on one side of the LED panel and covering the first and second lighting zones, wherein a plurality of diffusion lenses are provided at positions corresponding to the second lighting zone, each diffusion lens corresponding to one of the second LEDs;
Wherein the LED panel is electrically connectable to a preset external control switch, such that the control switch is configured to selectively activate only the first LEDs in the first lighting zone, or both the first LEDs and the second LEDs in the respective lighting zones simultaneously;
Wherein, when the second LEDs are activated, the emitted light from the second LEDs is refracted and diffused through the diffusion lenses of the light diffusion plate.

2. The lighting apparatus of claim 1, wherein the diffusion lenses are formed with a plurality of convex surface features.

3. The lighting apparatus of claim 1, wherein the control switch is one of a manual push-button switch, a remote control switch, or a voice-activated switch.

4. The lighting apparatus of claim 1, further comprising a lamp housing including a lamp base and a lamp cover, wherein the lamp base is provided with a receiving chamber for accommodating the LED panel, and the lamp cover is coupled with the lamp base to enclose the receiving chamber, the LED panel, and the light diffusion plate.

5. The lighting apparatus of claim 4, wherein the lamp cover includes a peripheral sidewall, the sidewall being transparent or semi-transparent, and a central region of the lamp cover being frosted.

6. The lighting apparatus of claim 4, wherein the lamp housing is installable on a ceiling fan.

7. The lighting apparatus of claim 1, wherein the control switch is further configured to activate only the second LEDs in the second lighting zone.

8. The lighting apparatus of claim 1, wherein the light diffusion plate includes a protruding convex column at a position corresponding to the first lighting zone.

9. A lighting apparatus with an adjustable illumination range, comprising:
An LED panel, having a first lighting zone disposed on one side thereof, the first lighting zone being provided with a plurality of first LEDs, and at least one ring-shaped second lighting zone disposed around the first lighting zone, the second lighting zone being provided with a plurality of second LEDs, wherein each second LED has a diffusion lens directly mounted on its light-emitting surface;
Wherein the LED panel is electrically connectable to a preset external control switch, such that the control switch is configured to selectively activate only the first LEDs in the first lighting zone, or both the first LEDs and the second LEDs simultaneously;
And wherein, when the second LEDs are activated, their emitted light is directly diffused and refracted through the respective diffusion lenses.

10. The lighting apparatus of claim 9, wherein the control switch is one of a manual push-button switch, a remote control switch (including those described in paragraph [0025]), or a voice-activated switch.

11. The lighting apparatus of claim 9, further comprising a lamp housing including a lamp base and a lamp cover, wherein the lamp base is provided with a receiving chamber for accommodating the LED panel, and the lamp cover is coupled with the lamp base to enclose the receiving chamber and the LED panel.

12. The lighting apparatus of claim 11, wherein the lamp cover includes a peripheral sidewall, the sidewall being transparent or semi-transparent, and a central region of the lamp cover being frosted.

13. The lighting apparatus of claim 11, wherein the lamp housing is installable on a ceiling fan.

14. The lighting apparatus of claim 9, wherein the control switch is further configured to activate only the second LEDs in the second lighting zone.
